(19) United States
(12) Patent Application Publication
(10) Pub. No.: US 2005/0077382 A1
(43) Pub. Date: Apr. 14, 2005

(54) Vehicle window clearing device

(76) Inventor: Nelson Gosser JR., Piracicaba (BR)

Correspondence Address: CARLSON, GASKEY & OLDS, P.C., 400 WEST MAPLE ROAD, SUITE 350, BIRMINGHAM, MI, 48009, US

(21) Appl. No.: 10/659,487

(22) Filed: Sep. 10, 2003

(51) Int. Cl. B05B 1/10; B60S 1/46; B05B 9/03

(52) U.S. Cl. 239/284.1; 239/284.2

(57) ABSTRACT

A vehicle window clearing assembly includes a fluid outlet directing a fluid stream across an exterior surface of a window. The fluid outlet is mounted on an exterior structure of a vehicle to direct fluid streams for clearing away moisture build up on the window exterior.

### BACKGROUND OF THE INVENTION

This invention generally relates to an assembly for clearing moisture from a vehicle window.

Typically, a vehicle door includes a window that may be movable between an open and closed position. In many instances, the window will become covered by rain, snow or ice. As such, the front windshield is provided with a window wiper system as is know. However, conventional side windows are not equipped with any type of device for removing moisture from the exterior surface.

Vehicle doors include window lift mechanisms and latch mechanisms that leave little space for additional accessories or assemblies. One known device for clearing a side window includes a wiper mounted within a portable housing. The portable housing mounts to the outside of the vehicle door. An electric cable provides power for an electric motor within the housing to actuate a wiper. The wiper sweeps across the window to remove moisture on an exterior surface of the window. This device provides some improvement in visibility, however, alignment difficulties between the surface of the window and the wiper blade may limit the capability of this device. Further, power to the device is provided by an electrical receptacle within the vehicle that requires inconvenient and undesirable routing of an electric wire through the vehicle door seal.

Accordingly, it is desirable to provide an inexpensive and uncomplicated device for clearing moisture and other debris from a vehicle window without mounting additional mechanisms within the vehicle.

### SUMMARY OF INVENTION

The present invention is a window clearing assembly including an air outlet directing an air stream across an exterior surface of a vehicle window.

The air outlet is mounted on an exterior structure of a vehicle to direct air streams for clearing away moisture build up on an exterior surface of the window to improve visibility through the window. A remotely located air source communicates air to the air outlet through a conduit. The air outlet is mounted to an exterior structure of the vehicle door such that air streams emanating from the air outlet flow across the exterior surface of the window.

Accordingly, the present invention provides a device for clearing moisture and other debris from a vehicle window without the mounting of additional bulky mechanisms and linkages.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic view of vehicle door with a window clearing assembly according to this invention;

FIG. 2 is an enlarged view of a side view mirror including the inventive clearing device;

FIG. 3 is an enlarged view of a side view mirror housing without the mirror;

FIG. 4 is another window clearing assembly designed according to the present invention;

FIG. 5 is another window clearing assembly designed according to the present invention; and

FIG. 6 is another window clearing assembly designed according to the present invention.

### DETAILED DESCRIPTION OF THE PREFERRED EMBODIMENT

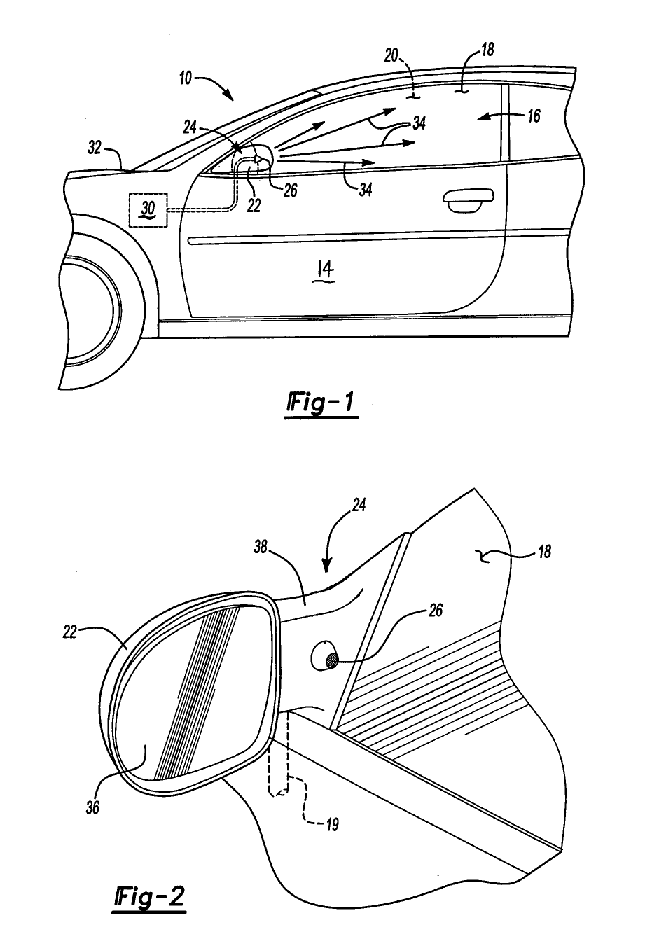

Referring to FIG. 1, a vehicle door 14 includes a window 16 that may be movable between an open and closed position. The window 16 includes an exterior surface 18 and an interior surface 20. In many instances, the window 16 will become covered by some type of moisture either in the form of rain, snow or ice.

A door module 10 built according to this invention includes an air outlet 24 directing air streams 34 across the exterior surface 18 of the window 16 for clearing moisture and other debris therefrom. Although air is discussed and illustrated, it is within the contemplation of this invention to emit any fluid or gas medium from the outlet 24 for clearing the exterior surface 18 of the window 16. The air outlet 24 includes an air nozzle 26 that directs the air streams 34 across the exterior surface 18 of the window 16.

An air or fluid soured is indicated at 30 and provides air through a conduit 19 to the air outlet 24. The air source 30 is schematically shown mounted within the vehicle with a conduit 19 running from the vehicle through the door 14 and to the air outlet 24. The conduit 19 is the only linkage required between the air source 30 and the air outlet 24. The conduit 19 is preferably a flexible hose transferring pressurized air to the air outlet 24. Because only the conduit 19 is required to pass through the door 14, minimal space within the vehicle door 14 is used for the window clearing device 11.

The air source 30 is an air pump driven by the main power generation device of the vehicle. However, it is within the contemplation of this invention that the air source 20 may be any type of pump, tank or other known device that can provide pressurized air or fluid to the air outlet 24. Further, the conduit 19 may be a hose, tube or pipe or any combination thereof for communicating pressurized air from the air source 30 and the air outlet 24.

The air outlet 24 is shown mounted to a side mirror housing 22. The air outlet includes a nozzle 26. The nozzle 26 shapes the flow of air from the air outlet 24 over the exterior surface 18 of the window 16. The nozzle 26 can be passive where air emanating form the air outlet 24 is directed over the window 16 by the configuration and shape of the nozzle 26. The nozzle 26 may also be active and move to direct air streams 34 in a sweeping motion across the exterior window 18.

The air stream 34 can be heated to a temperature above an ambient temperature, such that snow and ice are melted by exposure to the heated air stream 34. Heated air aids in the removal of ice and snow. Air may be heated as is known in the art, for example by use of a window defroster for interior surfaces of a vehicle windshield.

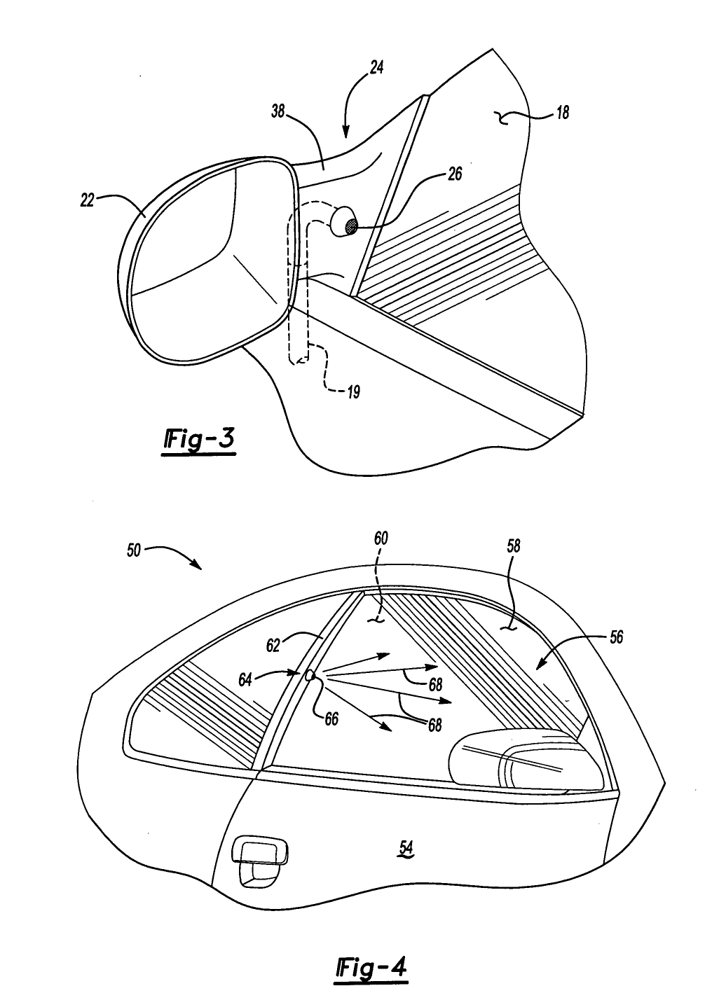

Referring to FIGS. 2 and 3, the side mirror housing 22 includes a mirror 36. The air outlet 24 is mounted within an integral housing feature 38 of the side view mirror housing 22. FIG. 3 is a view of the side mirror 22 without the mirror 36 illustrating the conduit 19 through the side mirror housing 22. The conduit 19 requires little space within the vehicle door 14 and the side mirror housing 22, and therefore does not require modification of internal vehicle door mechanisms.

Referring to FIG. 4, another window clearing assembly 50 includes an air outlet 64 mounted to a frame portion 62 of a vehicle door 54. A window 56 mounted within the vehicle door 54 includes an interior surface 60 and an exterior surface 58. The air outlet 64 includes a nozzle 66 that directs air streams 68 over the exterior surface 58 of the window 56. Air streams 68 emanating from the air outlet 64 flow over the exterior surface 58 of the window 56 to clear way moisture or debris deposited on the window 56. Because the debris and moisture is cleared away by air streams 68 instead of a mechanical wiper mechanism, complicated linkages are not required, and additional space within the vehicle door 54 is not required.

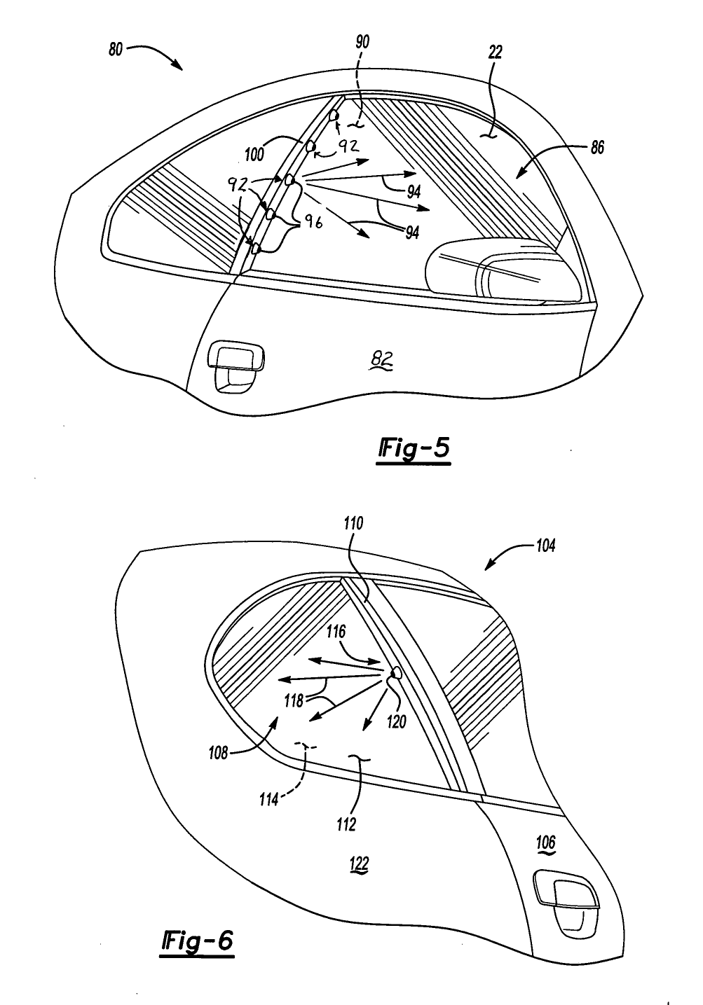

Referring to FIG. 5, a window clearing assembly 80 according to the present invention is mounted to a vehicle door 82 and includes a plurality of air outlets 92 disposed about a window 86. The window 86 includes interior and exterior surfaces 90, 88. The exterior surface 88 is cleared of debris by air streams 94 emanating from the air outlets 92 positioned on a frame 100, and a side view mirror housing 98. The plurality of air outlets 92 direct air streams 94 over the exterior surface 88 of the window 86.

Each of the plurality of air outlets 92 includes a nozzle 96 for directing air streams 96 over the exterior surface 88 of the window 86. The plurality of air outlets 92 provides coverage of the window exterior 88 for clearing moisture and debris from the window 86. Further, the air streams 94 may be heated to a temperature above ambient to melt snow or ice.

Referring to FIG. 6, a window clearing assembly 104 according to the present invention includes an air outlet 116 mounted to a fixed pillar 110 of the vehicle body 122. A window 108 having an interior surface 114 and an exterior surface 112 is fixed within the vehicle body 122. Air streams emanating from the air outlet 116 flow across the window 108 to clear moisture and other debris that may have accumulated on the exterior surface 112 of the window 108. The air outlet 116 includes a nozzle 120 for directing air streams 118 across the exterior surface 112 of the window 108.

Window clearing assemblies designed with the benefit of this disclosure provide for clearing of a vehicle window by directing air streams across the exterior surface of the window without space consuming mechanical linkages. Further, the window clearing assembly of this invention allows the removal of moisture and other debris without requiring alignment of a wiper assembly with a window within a vehicle door.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. A window clearing assembly for a window having an interior surface and an exterior surface, said assembly comprising:
a fluid outlet directing a fluid stream across the exterior surface of the window.

2. The assembly recited in claim 1, wherein said fluid outlet comprises a nozzle for directing said fluid stream across the exterior surface of the window.

3. The assembly recited in claim 1, wherein said fluid stream is heated.

4. The assembly recited in claim 1, comprising a source of pressurized fluid and a conduit between said source of pressurized fluid and said fluid outlet.

5. The assembly recited in claim 2, wherein said nozzle is movable to direct said fluid stream across the exterior surface of the window.

6. The assembly recited in claim 5, wherein said nozzle moves to produce a sweeping motion of said fluid streams across the exterior surface of the window.

7. The assembly recited in claim 1, wherein the window is assembled within a vehicle door and said fluid outlet is mounted to the vehicle door.

8. The assembly of claim 7, wherein the vehicle door comprises a side view mirror and said fluid outlet is mounted to the side view mirror.

9. The assembly of claim 7, wherein the vehicle door comprises a window frame portion, and said fluid outlet is mounted to the window frame portion.

10. The assembly of claim 1, comprising a plurality of fluid outlets mounted for directing fluid across the exterior surface of the window.

11. The assembly of claim 1, wherein said fluid outlet is mounted to a fixed structure of a vehicle.

12. The assembly of claim 11, wherein said fluid outlet is mounted to a pillar of a vehicle to direct said fluid streams across the exterior surface of the window.

13. A door module assembly for a vehicle door having a window with an interior and exterior surface, said assembly comprising:
a fluid outlet for directing a fluid stream onto said exterior surface of said window.

14. The assembly recited in claim 13, wherein said fluid outlet comprises a nozzle for directing said fluid stream across said exterior surface of said window.

15. The assembly recited in claim 13, wherein said fluid stream is heated.

16. The assembly recited in claim 13, further comprising a source of pressurized air and a conduit between said source of pressurized fluid and said fluid outlet.

17. The assembly recited in claim 13, wherein said nozzle is movable to direct said fluid stream across said exterior surface of said window.

18. The assembly of claim 13, further comprising a side view mirror, said fluid outlet mounted to said side view mirror.

19. The assembly of claim 13, further comprising a window frame portion, and said fluid outlet is mounted to said window frame portion.

20. The assembly of claim 13, further comprising a plurality of fluid outlets mounted for directing fluid across said exterior surface of said window.
